(19) United States
(12) Patent Application Publication
(10) Pub. No.: US 2025/0282932 A1
(43) Pub. Date: Sep. 11, 2025

(54) RUBBER COMPOSITION AND METHOD FOR PRODUCING SAME

(71) Applicant: TOAGOSEI CO., LTD., Tokyo (JP)

(72) Inventors: Akihiro GOTOU, Aichi (JP); Jun TAKADA, Aichi (JP); Ryo SAITO, Aichi (JP); Yuugo MIYATA, Aichi (JP)

(73) Assignee: TOAGOSEI CO., LTD., Tokyo (JP)

(21) Appl. No.: 18/861,407

(22) PCT Filed: May 9, 2023
(86) PCT No.: PCT/JP2023/017405

§ 371 Date: Oct. 29, 2024

(30) Foreign Application Priority Data
May 10, 2022 (JP) 2022-077333
Sep. 9, 2022 (JP) 2022-143977

(51) Int. Cl. C08K 7/02; C08L 7/02; C08L 9/10

(52) U.S. Cl. CPC C08K 7/02; C08L 7/02; C08L 9/10; C08K 2201/011

(57) ABSTRACT

A rubber composition containing a nanocellulose and a rubber component, wherein the nanocellulose contains an oxide of a cellulose raw material by a hypochlorous acid or a salt thereof and is substantially free of a N-oxyl compound. A rubber composition containing a nanocellulose and a rubber component, wherein the nanocellulose has an anion modification group, the rubber component is grafted to the nanocellulose.

### TECHNICAL FIELD

The present invention relates to a rubber composition and a method for producing the same.

### BACKGROUND ART

In recent years, as lightweight materials having excellent strength, rubbers whose strength is improved by adding thereto a reinforcing material have been widely used. In recent years, research on use of plant fibers as a reinforcing material for resins has progressed. Plant fibers are not artificially synthesized, but are used as released plant-derived fibers. Since hardly any plant fibers remain as ash when burnt, problems, e.g., disposal of ash in an incineration furnace and landfill disposal, do not occur. Therefore, research on use of plant fibers as a reinforcing material for resins has progressed, and particularly, research on use of nanocellulose obtained by fibrillating plant fibers to a nano level has been conducted.

As a type of nanocellulose, nanocellulose derived from oxides obtained by oxidizing raw material celluloses by a hypochlorous acid or a salt thereof is known. For example, Patent Document 1 discloses a method of producing nanocellulose including a step of producing oxidized cellulose by oxidizing a cellulose raw material using a hypochlorous acid or a salt thereof having an available chlorine concentration of 14 to 43 mass % and a step of performing a fibrillation treatment on the oxidized cellulose and forming the same into a nano size. In addition, Patent Document 2 discloses a method of producing nanocellulose including a step of oxidizing a cellulose raw material while adjusting the pH to a range of 5.0 to 14.0 using a hypochlorous acid or a salt thereof having an available chlorine concentration of 6 mass % to 14 mass %, and performing a fibrillation treatment on the oxidized cellulose and forming the same into a nano size.

Cellulose fibers are sometimes used as reinforcing materials in order to improve the strength of rubber, but when cellulose fibers are used as rubber reinforcing materials, if hydrophilic cellulose and hydrophobic rubber are combined, reinforcing materials have poor affinity and dispersibility in rubber and do not exhibit sufficient durability and rigidity. Here, Patent Document 3 discloses a rubber composition which contains cellulose nanofibers in a rubber component, wherein the cellulose fibers are composite cellulose fibers that are graft-polymerized with monomers or polymers in order to increase the affinity and dispersibility of nanocellulose in the rubber component.

### CITATION LIST

### Patent Document

Patent Document 1: WO 2018/230354
Patent Document 2: WO 2020/027307
Patent Document 3: Patent Publication JP-A-2009-263417

### SUMMARY OF INVENTION

### Technical Problem

When nanocellulose is blended into a rubber, the reinforcing effect on the rubber is expected, but it is desirable to further improve the strength of the rubber.

In Patent Documents 1 and 2, as nanocellulose, nanocellulose derived from an oxide obtained by oxidizing a raw material cellulose by a hypochlorous acid or a salt thereof is described, but blending the nanocellulose with a rubber is not specifically disclosed.

Patent Document 3 discloses that a radical initiator is blended into cellulose to generate radicals in the cellulose, and grafted cellulose fibers are obtained by graft polymerization. In the method of obtaining grafted cellulose fibers in Patent Document 3, since all of the functional groups of the cellulose are hydroxy groups, it is necessary to add a radical initiator into a specific dispersion medium in order to generate radicals. Therefore, there is a need for a method of efficiently obtaining a rubber composition in which grafting can be performed with a simpler operation than that of the grafted cellulose fibers in Patent Document 3.

The present invention has been made in view of the above circumstances, and an object of the present invention is to provide a rubber having excellent strength. In addition, an object of the present invention is to efficiently provide a rubber having excellent strength.

### Solution to Problem

The inventors conducted extensive studies and as a result, found that, when nanocellulose derived from an oxide obtained by oxidizing a cellulose raw material by a hypochlorous acid or a salt thereof is used as a material for a rubber, the strength of rubber, particularly the tensile strength, can be improved, and completed the present invention. In addition, the inventors conducted extensive studies and as a result, found that a rubber composition in which a rubber component is grafted to nanocellulose having an anion modification group allows the strength of the rubber to be efficiently improved, and the strength, particularly the tensile strength, to become excellent, and completed the present invention.

According to the present invention, the following aspects are provided.
[1] A rubber composition comprising a nanocellulose and a rubber component,
   wherein the nanocellulose comprises an oxide of a cellulose raw material by a hypochlorous acid or a salt thereof and is substantially free of a N-oxyl compound.
[2] A rubber composition comprising a nanocellulose and a rubber component,
   wherein the nanocellulose has an anion modification group, and
   wherein the rubber component is grafted to the nanocellulose.
[3] A rubber composition comprising a nanocellulose and a rubber component,
   wherein the nanocellulose comprises an oxide of a cellulose raw material by a hypochlorous acid or a salt thereof and is substantially free of a N-oxyl compound, and
   wherein the rubber component is grafted to the nanocellulose.
[4] A rubber obtained by crosslinking the rubber composition according to any one of [1] to [3].
[5] A method for producing a rubber composition comprising a nanocellulose and a rubber component, the method including
   a step of stirring a mixture comprising an oxidized cellulose and materials of the rubber composition except for the nanocellulose to fibrillate the oxidized cellulose and obtain the rubber composition,
   wherein the oxidized cellulose comprises an oxide of a cellulose raw material by a hypochlorous acid or a salt thereof and is substantially free of a N-oxyl compound.
[6] A method for producing a rubber composition comprising a nanocellulose and a rubber component, the method including
   a step of stirring an oxidized cellulose to fibrillate the oxidized cellulose and consecutively adding materials of the rubber composition except for the nanocellulose to obtain the rubber composition,
   wherein the oxidized cellulose comprises an oxide of a cellulose raw material by a hypochlorous acid or a salt thereof and is substantially free of a N-oxyl compound.
[7] The method according to [5] or [6], further including
   a step of grafting the nanocellulose and the rubber component.
[8] An additive for a rubber, the additive comprising a nanocellulose,
   wherein the nanocellulose comprises an oxide of a cellulose raw material by a hypochlorous acid or a salt thereof and is substantially free of a N-oxyl compound.
[9] An additive for a rubber, the additive comprising an oxidized cellulose,
   wherein the oxidized cellulose comprises an oxide of a cellulose raw material by a hypochlorous acid or a salt thereof and is substantially free of a N-oxyl compound.
[10] A composite nanocellulose comprising a rubber component and a nanocellulose,
   wherein the nanocellulose has an anion modification group, and
   wherein the rubber component and the nanocellulose are grafted.
[11] A composite nanocellulose comprising a rubber component and a nanocellulose,
wherein the nanocellulose comprises an oxide of a cellulose raw material by a hypochlorous acid or a salt thereof and is substantially free of a N-oxyl compound, and
wherein the rubber component and the nanocellulose are grafted.
[12] An additive for a rubber, the additive comprising the composite nanocellulose according to or [11].

### Advantageous Effects of Invention

According to the present invention, it is possible to provide a rubber having excellent strength.

### BRIEF DESCRIPTION OF DRAWINGS

FIG. 1 is a diagram showing the tensile stress/strain measurement results of rubbers of Examples 1 and 2 and Comparative Example 1.

FIG. 2 is a diagram showing the tensile stress/strain measurement results of rubbers of Examples 3 to 5 and Comparative Examples 2 and 3.

### DESCRIPTION OF EMBODIMENTS

In this specification, “oxidized cellulose” refers to an oxide of a cellulose raw material before fibrillation.

In this specification, “nanocellulose” refers to an oxide of a cellulose raw material after fibrillation.

In this specification, “composite nanocellulose” refers to a nanocellulose grafted to a rubber component.

### [Rubber Composition: First Aspect]

A rubber composition according to one aspect of the present invention contains nanocellulose and a rubber component, and the nanocellulose contains an oxide of a cellulose raw material by a hypochlorous acid or a salt thereof and is substantially free of N-oxyl compounds. This rubber composition is also referred to as a rubber composition of a first aspect.

The rubber composition of the present invention only needs to contain at least nanocellulose and a rubber component, and the rubber composition before crosslinking is what is referred to. The rubber composition of the present invention is used as a first rubber composition, and the rubber composition mixed with other rubbers may be used as a second rubber composition. That is, the rubber composition of the present invention may be used as a masterbatch, mixed with other rubbers or rubber components, and used to obtain a rubber.

According to the rubber composition of the first aspect, a rubber having excellent strength can be obtained. The reason for this is not clear, but is generally considered to be the following.

Nanocellulose is obtained through fibrillation, but fibrillation proceeds when hydrogen bonds between cellulose microfibrils break. In the oxidation treatment using hypochlorous acid or a salt thereof, it is thought that the degree of polymerization of microfibrils decreases (that is, the cellulose molecular chains become shorter) as the oxidation proceeds. Therefore, it is thought that, the number of hydrogen bonds to be broken by fibrillation in each microfibril is reduced according to the oxidation treatment, and additionally, the carboxy group content increases according to oxidation, the repulsive force between microfibrils is strengthened and the dispersion stability of the obtained nanocellulose is improved. It is thought that this dispersion stability is also exhibited in the rubber component, and the strength of the rubber, particularly the tensile strength, is improved.

### <<Nanocellulose of First Aspect>>

Nanocellulose of the first aspect is that formed by refining an oxide obtained by oxidizing a cellulose raw material by a hypochlorous acid or a salt thereof, that is, oxidized cellulose obtained by oxidizing a cellulose raw material by a hypochlorous acid or a salt thereof.

### <Oxidized Cellulose of First Aspect>

The oxidized cellulose of the first aspect is an oxidized cellulose obtained by oxidizing a cellulose raw material by a hypochlorous acid or a salt thereof. Here, the oxidized cellulose can also be referred to as an oxide of a cellulose raw material, and includes fibrous cellulose obtained by oxidizing a cellulose raw material by a hypochlorous acid or a salt thereof. The oxidized cellulose of the first aspect contains an oxide of a cellulose raw material by a hypochlorous acid or a salt thereof.

Here, the main component of plants is cellulose, and bundles of cellulose molecules are called cellulose microfibrils. Cellulose in the cellulose raw material is also contained in the form of cellulose microfibrils.

The oxidized cellulose of the first aspect includes a carboxy group, and the carboxy group may be in an H form (—COOH) or a salt form. The type of salt is not particularly limited, and examples thereof include alkali metal salts such as lithium, sodium, and potassium; alkaline earth metal salts such as calcium salts and barium salts; other metal salts such as magnesium salts and aluminum salts; and ammonium salts and organic amine salts.

The oxidized cellulose of the first aspect is obtained by oxidizing a cellulose raw material by a hypochlorous acid or a salt thereof, and N-oxyl compounds such as 2,2,6,6-tetramethylpiperidine-1-oxyl (hereinafter referred to as TEMPO) are not used in the oxidation. Therefore, the oxidized cellulose of the first aspect is substantially free of N-oxyl compounds. Therefore, the oxidized cellulose is highly safe because the impact of N-oxyl compounds on the environment and human body is sufficiently reduced. Here, in this specification, oxidized cellulose being “substantially free of N-oxyl compounds” means that no N-oxyl compound is used when oxidized cellulose is produced, oxidized cellulose contains no N-oxyl compounds, or the content of N-oxyl compounds (that is, the amount of nitrogen derived from N-oxyl compounds) with respect to a total amount of oxidized cellulose is 2.0 ppm by mass or less and preferably 1.0 ppm by mass or less. In addition, when the amount of nitrogen derived from N-oxyl compounds is preferably 2.0 ppm by mass or less and more preferably 1.0 ppm by mass or less as an addition from the cellulose raw material, this means “substantially free of N-oxyl compounds.” The amount of nitrogen derived from N-oxyl compounds can be measured by a known method. Examples of known methods include a method using a trace total nitrogen analysis device (for example, device name: TN-2100H, commercially available from Nittoseiko Analytech Co., Ltd.).

### (Carboxy Group Content)

The carboxy group content in the oxidized cellulose of the first aspect is preferably 0.20 to 2.0 mmol/g. When the carboxy group content is 0.20 mmol/g or more, sufficient ease-of-fibrillatability can be imparted to oxidized cellulose. Thereby, even if a fibrillation treatment is performed under mild conditions, it is possible to obtain a nanocellulose-containing slurry with uniform quality, and it is possible to improve the viscosity stability and handling properties of the slurry. On the other hand, when the carboxy group content is 2.0 mmol/g or less, it is possible to minimize excessive decomposition of cellulose during a fibrillation treatment, and it is possible to obtain nanocellulose with a small proportion of particulate cellulose and uniform quality. This is thought to enable the dispersibility to improve. In this regard, the carboxy group content of oxidized cellulose is more preferably 0.30 mmol/g or more, still more preferably 0.35 mmol/g or more, yet more preferably 0.40 mmol/g or more, yet more preferably 0.42 mmol/g or more, yet more preferably 0.50 mmol/g or more, yet more preferably more than 0.50 mmol/g, and yet more preferably 0.55 mmol/g or more. The upper limit of the carboxy group content may be less than 2.0 mmol/g, 1.5 mmol/g or less, 1.2 mmol/g or less, 1.0 mmol/g or less, or 0.9 mmol/g or less. A preferable range of the carboxy group content can be determined by appropriately combining the upper limits and lower limits described above. The carboxy group content of oxidized cellulose is more preferably 0.30 mmol/g or more and less than 2.0 mmol/g, still more preferably 0.35 to 2.0 mmol/g, yet more preferably 0.35 to 1.5 mmol/g, yet more preferably 0.40 to 1.5 mmol/g, yet more preferably 0.50 to 1.2 mmol/g, yet more preferably more than 0.50 to 1.2 mmol/g, and yet more preferably 0.55 to 1.0 mmol/g.

Here, when a 0.1 M hydrochloric acid aqueous solution is added to an aqueous solution in which oxidized cellulose is mixed with water, the pH is adjusted to 2.5, and a 0.05 N sodium hydroxide aqueous solution is then added dropwise, and the electrical conductivity is measured until the pH reaches 11.0, the carboxy group content (mmol/g) is a value calculated from the amount of sodium hydroxide (a) consumed in the neutralization stage of a weak acid with a mild change in the electrical conductivity using the following formula. Details follow the method described in examples to be described below. The carboxy group content can be adjusted by changing the reaction time, the reaction temperature, and the pH of the reaction solution and the like during the oxidation reaction.

Carboxy group content=a(ml)×0.05/mass(g) of oxidized cellulose

The oxidized cellulose can be obtained, for example, by oxidizing a cellulose raw material in a reaction system under conditions in which the available chlorine concentration of hypochlorous acid or a salt thereof is set to be a relatively high concentration (for example, 6 mass % to 43 mass %). In addition, the oxidized cellulose can be produced by appropriately controlling reaction conditions such as the available chlorine concentration, the pH during reaction, and the reaction temperature. The oxidized cellulose obtained in this manner preferably has a structure in which at least two of hydroxyl groups of a glucopyranose ring constituting cellulose are oxidized, and more specifically, preferably has a structure in which hydroxyl groups at the 2nd position and the 3rd position of the glucopyranose ring are oxidized and dicarboxy groups are introduced. In addition, it is preferable that the hydroxyl group at the 6th position of the glucopyranose ring in the oxidized cellulose not be oxidized and remain as a hydroxyl group. Here, the position of the carboxy group in the glucopyranose ring of the oxidized cellulose can be analyzed using the solid ¹³C-NMR spectrum.

Rayon has the same chemical structure as cellulose, and its oxide (rayon oxide) is water-soluble. When rayon oxide is dissolved in heavy water and solution one-dimensional ¹³C-NMR measurement is performed, a carbon peak belonging to a carboxy group is observed at 165 to 185 ppm. In one aspect of oxidized cellulose or nanocellulose obtained by oxidizing a cellulose raw material by hypochlorous acid or a salt thereof used in the present invention, two signals appear in this chemical shift range. In addition, according to solution two-dimensional NMR measurement, it can be determined that the carboxy group is introduced at the 2nd position and the 3rd position.

In solid ¹³C-NMR of oxidized cellulose or nanocellulose obtained by oxidizing a cellulose raw material by hypochlorous acid or a salt thereof, when the amount of carboxy groups introduced is large, two signals appear at 165 to 185 ppm, and when the amount of carboxy groups introduced is small, a very broad signal may appear. As can be seen from the results of rayon oxide, signals of carboxy group carbon atoms introduced at the 2nd position and the 3rd position are close to each other, and separation of two signals is insufficient in solid ¹³C-NMR with low resolution. Therefore, when the amount of carboxy groups introduced is small, a broad signal is observed. That is, in the solid ¹³C-NMR spectrum, when the spread of peaks appearing at 165 to 185 ppm is evaluated, it can be confirmed that the carboxy groups are introduced at the 2nd position and the 3rd position.

That is, after drawing a base line for peaks in the range of 165 ppm to 185 ppm in the solid ¹³C-NMR spectrum and obtaining a total area value, the ratio of two peak area values (large area value/small area value) obtained by vertically dividing the area value at the peak top is obtained, and if the ratio of the peak area values is 1.2 or more, it can be said that the peak is broad.

The presence/absence of this broad peak can also be evaluated using the ratio between the length L of the baseline for the range of 165 ppm to 185 ppm and the length L′ of the perpendicular line from the peak top to the baseline. Thus, it can be concluded that the broad peak is present when the ratio L′/L is greater than or equal to 0.1. This ratio L′/L may be greater than or equal to 0.2, greater than or equal to 0.3, greater than or equal to 0.4, or greater than or equal to 0.5. While the upper limit for the ratio L′/L is not particularly limited, in general it should be less than or equal to 3.0 and may be less than or equal to 2.0 or less than or equal to 1.0.

The structure of the aforementioned glucopyranose ring can also be determined by analysis based on the methodology described in Sustainable Chem. Eng. 2020, 8, 48, 17800-17806.

### (Degree of Polymerization)

The degree of polymerization of the oxidized cellulose of the first aspect is preferably 600 or less. When the degree of polymerization of the oxidized cellulose exceeds 600, it tends to require a large amount of energy for fibrillation, sufficient ease-of-fibrillatability cannot be exhibited, it tends to cause a decrease in dispersibility of pigments, and eventually, a decrease in optical density. In addition, when the degree of polymerization of the oxidized cellulose exceeds 600, the amount of oxidized cellulose that is insufficiently fibrillated increases. Therefore, when nanocellulose obtained by refining this is dispersed in a dispersion medium, light scattering and the like increase, and the dispersibility may decrease. In addition, the size of the obtained nanocellulose tends to vary, and the quality tends to be non-uniform. Therefore, when formed into nanocellulose, the viscosity of the dispersant tends to increase. In consideration of ease-of-fibrillatability, the lower limit of the degree of polymerization of the oxidized cellulose is not particularly set. However, when the degree of polymerization of the oxidized cellulose is less than 50, the proportion of particulate cellulose is larger than that of fibrous cellulose, and there is a risk of its function as a dispersant deteriorating. In view of the above viewpoint, the degree of polymerization of the oxidized cellulose is preferably in a range of 50 or more and 600 or less.

The degree of polymerization of the oxidized cellulose is more preferably 580 or less, still more preferably 560 or less, yet more preferably 550 or less, yet more preferably 500 or less, yet more preferably 450 or less, and yet more preferably 400 or less. The lower limit of the degree of polymerization is more preferably 60 or more, still more preferably 70 or more, yet more preferably 80 or more, yet more preferably 90 or more, yet more preferably 100 or more, yet more preferably 110 or more, and particularly preferably 120 or more. A preferable range of the degree of polymerization can be determined by appropriately combining the upper limits and lower limits described above. The degree of polymerization of the oxidized cellulose is more preferably 60 to 600, still more preferably 70 to 600, yet more preferably 80 to 600, yet more preferably 80 to 550, yet more preferably 80 to 500, yet more preferably 80 to 450, and particularly preferably 80 to 400.

Here, the degree of polymerization of the oxidized cellulose can be adjusted by changing the reaction time, the reaction temperature, the pH and the available chlorine concentration of hypochlorous acid or a salt thereof during the oxidation reaction. Specifically, since the degree of polymerization tends to decrease when the degree of oxidation increases, in order to reduce the degree of polymerization, for example, methods of increasing the oxidation reaction time and/or reaction temperature may be exemplified. As another method, the degree of polymerization of the oxidized cellulose can be adjusted according to stirring conditions of the reaction system during the oxidation reaction. For example, under conditions in which the reaction system is sufficiently uniformized using a stirring blade or the like, the oxidation reaction smoothly proceeds, and the degree of polymerization tends to decrease. On the other hand, under conditions in which the reaction system is likely to be insufficiently stirred such as by stirring with a stirrer, the reaction tends to be non-uniform, and it is difficult to sufficiently reduce the degree of polymerization of the oxidized cellulose. In addition, the degree of polymerization of the oxidized cellulose tends to vary depending on the selection of the cellulose raw material. Therefore, the degree of polymerization of the oxidized cellulose can be adjusted by selecting the cellulose raw material. Here, in this specification, the degree of polymerization of the oxidized cellulose is the average degree of polymerization (viscosity average degree of polymerization) measured by a viscosity method. The degree of polymerization of the oxidized cellulose can be specifically measured by the following [Measurement of viscosity average degree of polymerization].

### [Measurement of Viscosity Average Degree of Polymerization]

The oxidized cellulose is added to an aqueous sodium borohydride solution that is adjusted to pH 10, and a reduction treatment is run for 5 hours at 25° C. The amount of sodium borohydride is 0.1 g per 1 g of the oxidized cellulose. After the reduction treatment, solid-liquid separation and water washing are performed by suction filtration, and the obtained oxidized cellulose is freeze-dried. 0.04 g of the dried oxidized cellulose is added to 10 mL pure water; stirring is performed for 2 minutes; and 10 mL of a 1 M cupriethylenediamine solution is added and dissolution is carried out. Then, using a capillary viscometer, the efflux time of a blank solution and the efflux time of the cellulose solution are measured at 25° C. The relative viscosity (ηᵣ), specific viscosity (ηₛₚ), and intrinsic viscosity ([η]) are determined in order using the following formulas from the efflux time (t0) for the blank solution, the efflux time (t) for the cellulose solution, and the oxidized cellulose concentration (c [g/mL]), and the degree of polymerization (DP) of the oxidized cellulose is calculated using the viscosity law formula.

$${η}_{r} = η / {η}_{0} = t / t 0$$

$${η}_{sp} = {η}_{r} - 1$$

$$[ η ] = {η}_{sp} / ( 100 \times c ( 1 + 0 \text{.28} {η}_{sp} ) )$$

$$DP = 175 \times [ η ]$$

### (Method for Producing Oxidized Cellulose of First Aspect)

An oxidized cellulose of the first aspect can be produced by oxidizing a cellulose raw material by a hypochlorous acid or a salt thereof.

The cellulose raw material is not particularly limited as long as it is a material mainly composed of cellulose, and examples thereof include pulp, natural cellulose, regenerated cellulose, and fine cellulose depolymerized by mechanically treating cellulose. As the cellulose raw material, commercially available products such as crystal cellulose made from pulp can be used as such. In addition, unused biomass containing a large amount of cellulose components such as bean curd leftovers and soybean hulls may be used as a raw material. In addition, in order to facilitate permeation of an oxidant to be used into the raw material pulp, the cellulose raw material may be treated with an alkali having an appropriate concentration in advance.

Examples of specific production methods include methods described in WO 2022/009979 and WO 2022/009980. Commercial oxidized cellulose products are available, and for example, Aronfibro (registered trademark, commercially available from Toagosei Co., Ltd.) may be used.

The oxidized cellulose is preferably in a form of a dispersed liquid. The dispersed liquid here is a suspension containing oxidized cellulose. The dispersed liquid may contain a solvent used during oxidation. In addition, a dispersion medium may be appropriately added to form a dispersed liquid. Since the oxidized cellulose is a dispersed liquid, it is easy to handle and tends to be easily refined.

When the oxidized cellulose of the first aspect is a dispersed liquid, the amount of oxidized cellulose with respect to a total amount of 100 mass % of the dispersed liquid is generally in a range of 0.1 mass % or more and 95 mass % or less, preferably 1 mass % or more and 50 mass % or less, and more preferably 1 mass % or more and 30 mass % or less.

At least a part of the oxidized cellulose of the first aspect is refined into the rubber composition of the present invention to form nanocellulose. This nanocellulose can have the same form as in the following (nanocellulose).

### <Nanocellulose of First Aspect>

The nanocellulose of the first aspect is obtained by refining an oxidized cellulose obtained by oxidizing a cellulose raw material by a hypochlorous acid or a salt thereof. Here, the oxidized cellulose can have a form as described in the above <Oxidized cellulose of first aspect>. The nanocellulose of the first aspect can be derived from oxidized cellulose obtained by oxidizing a cellulose raw material by a hypochlorous acid or a salt thereof. The nanocellulose of the first aspect contains an oxide of a cellulose raw material by a hypochlorous acid or a salt thereof.

The nanocellulose of the first aspect is a generic term for refined cellulose, and includes fine cellulose fibers, cellulose nano crystals and the like. The fine cellulose fibers are also called cellulose nanofibers (also referred to as CNF).

The nanocellulose of the first aspect includes a carboxy group, and the carboxy group may be in an H form (—COOH) or a salt form. The type of salt is not particularly limited, and examples thereof include alkali metal salts such as lithium, sodium, and potassium; alkaline earth metal salts such as calcium salts and barium salts; other metal salts such as magnesium salts and aluminum salts; and ammonium salts and organic amine salts.

The nanocellulose of the first aspect is obtained by oxidizing a cellulose raw material by a hypochlorous acid or a salt thereof, and N-oxyl compounds such as TEMPO are not used in the oxidation. Therefore, nanocellulose of the first aspect is substantially free of N-oxyl compounds. The definition of nanocellulose being “substantially free of N-oxyl compounds” is the same as the definition of oxidized cellulose being “substantially free of N-oxyl compounds” described in the above

### <Oxidized Cellulose of First Aspect>.

### (Carboxy Group Content)

The carboxy group content in the nanocellulose of the first aspect is preferably the same as that described in the above <Oxidized cellulose of first aspect>.

The carboxy group content (mmol/g) in the nanocellulose can be measured by the same method as the method of measuring the carboxy group content of oxidized cellulose described above.

The nanocellulose of the first aspect is a single unit fiber or an assembly of the fibers. When the nanocellulose includes carboxylated nanocellulose, it is sufficient that the fiber assembly contain at least one carboxylated nanocellulose, and the carboxylated nanocellulose is preferably a main component. Here, when the carboxylated nanocellulose is a main component, it means that the proportion of carboxylated nanocellulose with respect to a total amount of nanocellulose is more than 50 mass %, preferably more than 70 mass %, and more preferably more than 80 mass %. The upper limit of the proportion is 100 mass %, but it may be 98 mass % or 95 mass %.

### (Average Fiber Length)

The average fiber length of the nanocellulose of the first aspect is preferably 50 to 700 nm, more preferably 50 to 500 nm, still more preferably 50 to 300 nm, yet more preferably 60 to 300 nm, and yet more preferably 70 to 200 nm. When the average fiber length exceeds 700 nm, the slurry will thicken significantly and become difficult to handle. In addition, when the average fiber length is less than 50 nm, it becomes difficult for it to exhibit the viscosity, which is a feature of nanocellulose.

### (Average Fiber Width)

The average fiber width of the nanocellulose of the first aspect is preferably 1 to 200 nm, more preferably 1 to 15.0 nm, still more preferably 1 to 10 nm, and yet more preferably 1 to 5 nm. When the average fiber width is less than 1 nm, it becomes difficult to improve the strength of the resin containing nanocellulose. In addition, when the average fiber width is larger than 200 nm, the ejection stability in inkjet printing may deteriorate when the nanocellulose is used in an ink composition.

Here, when nanocellulose and water are mixed so that the nanocellulose concentration is approximately 1 to 10 ppm, a sufficiently diluted cellulose aqueous dispersion is naturally dried on a mica substrate, the shape of nanocellulose is observed using a scanning probe microscope, and an arbitrary number of fibers are randomly selected from the obtained image, the average fiber width and the average fiber length are values calculated by setting cross-sectional height of shape image=fiber width, and peripheral length/2=fiber length. Image processing software can be used to calculate such an average fiber width and average fiber length. In this case, image processing conditions are arbitrary, but values calculated for the same image may differ depending on conditions. The range of differences in values depending on conditions is preferably within a range of +100 nm for the average fiber length. The range of differences in values depending on conditions is preferably within a range of +10 nm for the average fiber width.

### (Aspect Ratio)

In the nanocellulose of the first aspect, the aspect ratio (average fiber length/average fiber width), which is a ratio between the average fiber width and the average fiber length, is preferably 20 or more and 200 or less.

It is thought that, when the aspect ratio is 200 or less, the dispersibility of nanocellulose is improved, and binding properties can be further improved. In this regard, the aspect ratio is more preferably 190 or less, and still more preferably 180 or less.

On the other hand, when the aspect ratio is too low, that is, when the shape of nanocellulose is a thick rod shape rather than an elongated fibrous shape, uneven distribution causes aggregation, and the dispersibility tends to decrease. Therefore, the aspect ratio is preferably 20 or more, more preferably 30 or more, and still more preferably 40 or more.

The nanocellulose of the first aspect preferably satisfies the following zeta potential and light transmittance.

### (Zeta Potential)

The zeta potential of the nanocellulose of the first aspect is preferably −30 mV or less. When the zeta potential is-30 mV or less (that is, the absolute value is 30 mV or more), sufficient repulsion between microfibrils is obtained, and nanocellulose with a high surface charge density is likely to be produced during mechanical fibrillation. Thereby, the dispersion stability of nanocellulose is improved, and viscosity stability and handling properties when made into a slurry can be improved.

The lower limit value of the zeta potential is not particularly limited, and may be generally −100 mV or more.

When the zeta potential is-100 mV or more (that is, the absolute value is 100 mV or less), since oxidative cutting in the fiber direction tends to be minimized as oxidation proceeds, nanocellulose with a uniform size can be obtained, the nanocellulose is stable and highly dispersible in water, and the nanocellulose is uniformly contained the obtained dispersed liquid.

In view of the above viewpoint, the zeta potential of the nanocellulose is preferably −35 mV or less, more preferably −40 mV or less, and still more preferably-50 mV or less. In addition, the lower limit of the zeta potential is preferably −90 mV or more, more preferably −85 mV or more, still more preferably −80 mV or more, yet more preferably −77 mV or more, yet more preferably −70 mV or more, and yet more preferably −65 mV or more. The range of the zeta potential can be determined by appropriately combining the above lower limit and upper limit. The zeta potential is preferably −90 mV or more and −30 mV or less, more preferably −85 mV or more and −30 mV or less, still more preferably −80 mV or more and −30 mV or less, yet more preferably −77 mV or more and −30 mV or less, yet more preferably −70 mV or more and −30 mV or less, yet more preferably −65 mV or more and −30 mV or less, and yet more preferably −65 mV or more and −35 mV or less.

Here, in this specification, the zeta potential is a value measured under conditions of a pH of 8.0 and 20° C. for a cellulose aqueous dispersion in which nanocellulose and water are mixed and the nanocellulose concentration is 0.1 mass %. Specifically, the zeta potential can be measured according to conditions to be described below.

### [Zeta Potential Measurement]

Pure water is added to the dispersion containing nanocellulose, and dilution is performed so that the nanocellulose concentration is 0.1%. 0.05 mol/L of a sodium hydroxide aqueous solution is added to the diluted nanocellulose aqueous dispersion, the pH is adjusted to 8.0, and the zeta potential is measured at 20° C. using a zeta electrometer (ELSZ-1000, commercially available from Otsuka Electronics Co., Ltd.).

### (Light Transmittance)

A nanocellulose dispersion obtained by dispersing the nanocellulose of the first aspect in a dispersion medium can exhibit high light transmittance with little light scattering of cellulose fibers. Specifically, the nanocellulose of the first aspect preferably has a light transmittance of 95% or more in a mixed solution obtained by mixing with water and having a solid content concentration of 0.1 mass %. The light transmittance is more preferably 96% or more, still more preferably 97% or more, and yet more preferably 99% or more. Here, the light transmittance is a value measured with a spectrophotometer at a wavelength of 660 nm. In addition, the light transmittance can be measured using an aqueous dispersion containing nanocellulose. Specifically, the light transmittance can be measured according to conditions to be described below.

### [Light Transmittance Measurement]

The nanocellulose aqueous dispersion with a solid content concentration of 0.1 mass % is put into a quartz cell with a thickness of 10 mm, and the light transmittance at a wavelength of 660 nm is measured using a spectrophotometer (JASCO V-550).

The zeta potential and the light transmittance can be controlled by performing oxidation by a hypochlorous acid or a salt thereof, and particularly, can be controlled by adjusting the reaction time, reaction temperature, stirring conditions and the like for the oxidation reaction. Specifically, as the reaction time and/or the reaction temperature increases, oxidation on the surface of cellulose microfibrils in the cellulose raw material proceeds, and the average fiber width tends to become smaller due to stronger repulsion between fibrils due to electrostatic repulsion and osmotic pressure. In addition, the zeta potential tends to be increased by setting one or more of the oxidation reaction time, reaction temperature, and stirring conditions (for example, lengthening the reaction time) for the side on which oxidation further proceeds (that is, the side on which the degree of oxidation increases).

The nanocellulose of the first aspect may be subjected to a hydrophobic treatment. Hydrophobization may be performed through ester, urethane, ether bonds, and the like with the surface hydroxyl groups of nanocellulose or through ionic bonds with carboxy groups. Molecules for hydrophobization are not particularly limited, and any molecule having a functional group that can form the above bonds can be used. The hydrophobic treatment can be performed, for example, by performing a hydrophobization reaction on nanocellulose obtained by fibrillation in (Method for producing nanocellulose of first aspect) to be described below.

### (Method for Producing Nanocellulose of First Aspect)

The nanocellulose of the first aspect can be produced by fibrillating the above oxidized cellulose. Examples of specific production methods include methods described in WO 2022/009979 and WO 2022/009980. Nanocellulose can also be obtained by fibrillating a commercially available oxidized cellulose (for example, Aronfibro (registered trademark), commercially available from Toagosei Co., Ltd.).

### <<Rubber Component>>

The rubber component used in the present invention is one that is crosslinked to form a rubber. The rubber component used in the present invention is not particularly limited, and a commercially available product can be used, and it may be a synthetic rubber component or a natural rubber component.

Examples of natural rubber components include natural rubber polymers not subjected to chemical modification; chemically modified natural rubber polymers such as chlorinated natural rubber polymers, chlorosulfonated natural rubber polymers, and epoxidized natural rubber polymers; hydrogenated natural rubber polymers; and deproteinized natural rubber polymers.

Examples of synthetic rubber components include diene rubber polymers such as butadiene rubber (BR) polymers, styrene-butadiene copolymer rubber (SBR) polymers, isoprene rubber (IR) polymers, acrylonitrile-butadiene rubber (NBR) polymers, chloroprene rubber (CR) polymers, styrene-isoprene copolymer rubber polymers, styrene-isoprene-butadiene copolymer rubber polymers, and isoprene-butadiene copolymer rubber polymers; and non-diene rubber polymers such as butyl rubber (IIR) polymers, ethylene-propylene rubber (EPM, EPDM) polymers, acrylic rubber (ACM) polymers, epichlorohydrin rubber (CO, ECO) polymers, fluorine rubber (FKM) polymers, silicone rubber (Q) polymers, urethane rubber (U) polymers, and chlorosulfonated polyethylene (CSM) polymers.

These rubber components may be used alone or two or more thereof may be used in combination.

The form of the rubber component may be a solid, a dispersed liquid (latex) in which the rubber component is dispersed in a dispersion medium, or a solution dissolved in a solvent. The dispersion medium and the solvent may be, for example, water or an organic solvent. The amounts of the dispersion medium and the solvent may each be 10 to 1,000 parts by mass with respect to 100 parts by weight of the rubber component.

The rubber component in the present invention may be one before crosslinking or at least a part of the rubber component may be crosslinked.

### <<Method for Producing Rubber Composition of First Aspect>>

The rubber composition of the first aspect can be produced by, for example, a production method including a step of mixing nanocellulose of the first aspect, that is, nanocellulose which contains an oxide of a cellulose raw material by a hypochlorous acid or a salt thereof and is substantially free of N-oxyl compounds with a rubber component.

The oxidized cellulose of the first aspect used in the present invention is fibrillated into nanocellulose in the composition by a dispersing operation or a kneading operation during production. Specifically, the oxidized cellulose and other materials contained in the rubber composition may be blended, dispersed or kneaded to fibrillate the mixture, or may be fibrillated by the manufacturer of the rubber composition him/herself and refined to form nanocellulose. The rubber composition of the first aspect of the present invention can be produced using oxidized cellulose which contains an oxide of a cellulose raw material by a hypochlorous acid or a salt thereof and is substantially free of N-oxyl compounds.

One aspect of the present invention is a method for producing a rubber composition containing nanocellulose and a rubber component, and the production method includes a step of stirring a mixture containing oxidized cellulose and materials of the rubber composition except for the nanocellulose to obtain the rubber composition, wherein the oxidized cellulose contains an oxide of a cellulose raw material by a hypochlorous acid or a salt thereof and is substantially free of N-oxyl compounds.

In addition, one aspect of the present invention is a method for producing a rubber composition containing nanocellulose and a rubber component, and the production method includes a step of stirring oxidized cellulose, consecutively adding materials of the rubber composition except for the nanocellulose to obtain the rubber composition, wherein the oxidized cellulose contains an oxide of a cellulose raw material by a hypochlorous acid or a salt thereof and is substantially free of N-oxyl compounds.

Here, the forms of nanocellulose, oxidized cellulose, and the rubber component are as described above. Materials of the rubber composition except for the nanocellulose are arbitrary materials that can be contained in the rubber composition except for the nanocellulose.

### [Rubber Composition: Second Aspect]

A rubber composition which is one aspect of the present invention contains a nanocellulose and a rubber component, the nanocellulose has an anion modification group, and the rubber component is grafted to the nanocellulose. This rubber composition is also referred to as a rubber composition of a second aspect. Grafting refers to chemical bonding of molecular chains of the rubber component to nanocellulose. The chemical bond is preferably a covalent bond.

Here, at least a part of the rubber component contained in the rubber composition may be grafted to nanocellulose. In addition, at least a part of the nanocellulose contained in the rubber composition may be grafted to the rubber component.

Here, it is thought that, in grafting, radicals are generated from functional groups contained in the nanocellulose, that is, anion modification groups and/or hydroxy groups, double bonds in the rubber component are bonded, and thus the nanocellulose and the rubber component form an interaction. However, the form of grafting in the present invention is not limited thereto.

According to the rubber composition of the second aspect, as in the rubber composition of the first aspect, the strength of the rubber, particularly the tensile strength, can be improved. The reason why the strength of the rubber is improved is thought to be that, when the rubber component is grafted to the nanocellulose, the affinity between the composite nanocellulose grafted to a rubber component and the rubber component increases, the composite nanocellulose is easily dispersed in the rubber component, and the strength, particularly the tensile strength, is improved. The reason for the increase in strength is not limited to this.

### <<Nanocellulose of Second Aspect>>

The nanocellulose of the second aspect has an anion modification group. In this specification, the anion modification group refers to a group that generates anions. The anion modification group is not particularly limited, and examples thereof include a carboxy group, phosphate group, phosphite group, sulfate group, and xanthate ester group.

Regarding introduction of an anion modification group into nanocellulose, for example, an anion modification group is introduced into a cellulose raw material and fibrillation is then performed to obtain nanocellulose having an anion modification group or an anion modification group may be introduced into nanocellulose, and the method is not limited. In addition, the anionic group can be introduced, for example, by converting a part of the cellulose structure into an anion modification group or can be introduced by reacting a cellulose structure with a compound having an anion modification group or a compound that generates an anion modification group by reaction with the cellulose structure (also referred to as an anion modification agent).

For nanocellulose having a carboxy group, for example, a cellulose raw material is oxidized with an oxidant to produce oxidized cellulose having a carboxy group, and the oxidized cellulose can be fibrillated to obtain nanocellulose having a carboxy group.

In addition, nanocellulose having a carboxy group can be obtained, for example, by fibrillating carboxymethylated cellulose. For carboxymethylated cellulose, specifically, carboxymethylated cellulose can be obtained by mercerizing a cellulose raw material in the presence of a solvent and then performing an etherification reaction. As a mercerizing agent, for example, alkali metal hydroxides such as sodium hydroxide and potassium hydroxide can be used. As a carboxymethylating agent, for example, sodium monochloroacetate can be used.

In addition, nanocellulose having a carboxy group can also be obtained by, for example, reacting commercially available nanocellulose with maleic acid or itaconic acid.

Nanocellulose having a phosphate group can be obtained, for example, by reacting a cellulose raw material with a compound having a phosphate group such as phosphoric acid, sodium dihydrogen phosphate, disodium hydrogen phosphate, trisodium phosphate, sodium pyrophosphate, sodium metaphosphate, potassium dihydrogen phosphate, dipotassium hydrogen phosphate, tripotassium phosphate, potassium pyrophosphate, potassium metaphosphate, ammonium dihydrogen phosphate, diammonium hydrogen phosphate, triammonium phosphate, ammonium pyrophosphate, and ammonium metaphosphate to form cellulose having a phosphate group and then fibrillating the cellulose having a phosphate group.

Nanocellulose having a phosphite group can be obtained, for example, by reacting a cellulose raw material with a phosphorus oxoacid (sodium hydrogen phosphate or sodium hydrogen phosphite) and urea, and then performing fibrillation.

Nanocellulose having a sulfate group can be obtained, for example, by adding a cellulose raw material to a solution containing dimethyl sulfoxide (DMSO), acetic anhydride, and sulfuric acid, reacting the mixture, and performing fibrillation.

Nanocellulose having a xanthate ester group can be performed, for example, by treating a cellulose raw material with an alkali using a sodium hydroxide aqueous solution as necessary, then reacting it with carbon disulfide, and then performing fibrillation.

As the anion modification group of the nanocellulose of the second aspect, a carboxy group is preferable. The nanocellulose having a carboxy group is preferably nanocellulose obtained by a production method including TEMPO oxidation and the above <<Nanocellulose of first aspect>>. As the nanocellulose obtained by a production method including TEMPO oxidation, a commercially available product may be used, or one produced according to Angew. Chem. Int. Ed. 2021, 60, 24630-24636 may be used.

The nanocellulose of the second aspect is more preferably the above <<Nanocellulose of first aspect>> in consideration of grafting efficiency. That is, the nanocellulose of the second aspect more preferably contains an oxide of a cellulose raw material by a hypochlorous acid or a salt thereof and is substantially free of N-oxyl compounds. When nanocellulose which contains an oxide of a cellulose raw material by a hypochlorous acid or a salt thereof and is substantially free of N-oxyl compounds is used, the concentration of nanocellulose during grafting can increase, and the production efficiency can increase. When the nanocellulose of the second aspect contains an oxide of a cellulose raw material by a hypochlorous acid or a salt thereof and is substantially free of N-oxyl compounds, the aspect thereof is as described in the above <<Nanocellulose of first aspect>>.

The nanocellulose of the second aspect is a single unit fiber or an assembly of the fibers. When the nanocellulose includes nanocellulose having an anion modification group, it is sufficient that the fiber assembly contain nanocellulose having at least one anion modification group, and the nanocellulose having an anion modification group is preferably a main component. Here, when the nanocellulose having an anion modification group is a main component, it means that the proportion of the nanocellulose having an anion modification group with respect to a total amount of nanocellulose is more than 50 mass %, preferably more than 70 mass %, and more preferably more than 80 mass %. The upper limit of the proportion is 100 mass %, but it may be 98 mass % or 95 mass %.

The average fiber length, aspect ratio, and average fiber width of the nanocellulose of the second aspect are preferably the same as those of the nanocellulose of the first aspect. Here, the average fiber length and the average fiber width of the nanocellulose of the second aspect are those of nanocellulose before being grafted.

The rubber component of the second aspect can have the same form as <<Rubber component>> of the first aspect described above.

The nanocellulose in the rubber composition of the second aspect has an anion modification group, and the rubber component is grafted to the nanocellulose. Grafting can be performed by generating radicals in nanocellulose and reacting them with the rubber component, and radicals can be preferably generated by UV irradiation. That is, a composite nanocellulose grafted to a rubber component can be produced according to a step of grafting by performing UV irradiation on a mixture containing nanocellulose and a rubber component. One aspect of the present invention is a composite nanocellulose containing a rubber component and nanocellulose, wherein the nanocellulose has an anion modification group, and the rubber component and the nanocellulose are grafted.

### <<Method for Producing Rubber Composition of Second Aspect>>

The rubber composition of the second aspect can be produced, for example, by a production method including a step of mixing the nanocellulose of the second aspect, that is, nanocellulose having an anion modification group with a rubber component to obtain a mixture and a step of grafting by performing UV irradiation on the mixture.

The mixture may contain a dispersion medium. The dispersion medium is not particularly limited as long as it is one in which nanocellulose and/or a rubber component is dispersed and it does not inhibit grafting, and examples thereof include water, alcohols, ethers, ketones, N,N-dimethylformamide, N,N-dimethylacetamide, and dimethyl sulfoxide. As the dispersion medium, one of these may be used alone or two or more thereof may be used in combination. Among the dispersion media, examples of alcohols include methanol, ethanol, isopropanol, isobutanol, sec-butyl alcohol, tert-butyl alcohol, methyl cellosolve, ethylene glycol and glycerin. Examples of ethers include ethylene glycol dimethyl ether, 1,4-dioxane and tetrahydrofuran. Examples of ketones include acetone and methyl ethyl ketone. Among these dispersion media, water is preferable.

In order to remove oxygen that inhibits generation of radicals from the mixture, it is preferable to remove oxygen from the mixture. Removal of oxygen from the mixture can be performed by bubbling an inert gas.

UV irradiation to the mixture can be performed using, for example, a high pressure mercury lamp.

The temperature during UV irradiation is not particularly limited, and may be generally in a range of 0° C. or higher and 100° C. or lower, 0° C. or higher and 70° C. or lower, or 10° C. or higher and 50° C. or lower.

When the rubber composition of the second aspect contains the nanocellulose of the first aspect, the rubber composition of the second aspect can be produced using the oxidized cellulose of the first aspect.

That is, one aspect of the present invention is a method for producing a rubber composition containing a composite nanocellulose grafted to a rubber component and a rubber component, and the production method includes a step of stirring a mixture containing oxidized cellulose and materials of the rubber composition except for the nanocellulose to obtain a mixture containing the nanocellulose and the rubber component and a step of grafting by performing UV irradiation on the mixture, wherein the oxidized cellulose contains an oxide of a cellulose raw material by a hypochlorous acid or a salt thereof and is substantially free of N-oxyl compounds.

In addition, one aspect of the present invention is a method for producing a rubber composition containing a composite nanocellulose grafted to a rubber component and a rubber component, and the production method includes a step of stirring oxidized cellulose, consecutively adding materials of the rubber composition except for the nanocellulose to obtain a mixture containing the nanocellulose and the rubber component and a step of grafting by performing UV irradiation on the mixture, wherein the oxidized cellulose contains an oxide of a cellulose raw material by a hypochlorous acid or a salt thereof and is substantially free of N-oxyl compounds.

Here, the forms of nanocellulose, oxidized cellulose, and the rubber component are as described above. Materials of the rubber composition except for the nanocellulose are arbitrary materials that can be contained in the rubber composition except for the nanocellulose.

In each of the rubber compositions of the first and second aspects of the present invention, the blending ratio of the nanocellulose and the rubber component is not particularly limited, and the proportion of the nanocellulose with respect to 100 parts by mass of the rubber component (solid content) is preferably in a range of 0.1 parts by mass or more and 50 parts by mass or less, more preferably in a range of 0.1 parts by mass or more and 30 parts by mass or less, still more preferably in a range of 0.1 parts by mass or more and 15 parts by mass or less, and yet more preferably in a range of 0.5 parts by mass or more and 15 parts by mass or less. [Rubber]

One aspect of the present invention is a rubber (a crosslinked product of a rubber composition) obtained by crosslinking the rubber composition of the present invention, that is, the rubber composition of the first or second aspect. The rubber of the present invention can be obtained by heating the rubber composition of the present invention and/or adding a crosslinking agent to the rubber composition of the present invention.

In addition, when the rubber of the present invention is obtained, the rubber composition of the present invention may be kneaded in the presence of a crosslinking agent as necessary and then crosslinked to form a rubber. This tends to further improve the strength of the rubber.

When the rubber of the present invention is used as a first rubber, it may be additionally kneaded with other rubber components to form a second rubber. That is, the rubber composition of the present invention may be used as a masterbatch, and other rubbers and rubber components may be mixed to obtain a rubber.

Examples of crosslinking agents used to obtain the rubber of the present invention include sulfur, metal oxides, resin crosslinking agents, organic peroxides, and triazine derivatives. These may be used alone or two or more thereof may be used in combination.

Examples of sulfur include powdered sulfur, fine sulfur, precipitated sulfur, colloidal sulfur, and sulfur chloride.

Examples of metal oxides include magnesium oxide, calcium oxide, zinc oxide, and copper oxide.

Examples of resin crosslinking agents include alkylphenol formaldehyde resins such as alkylphenol formaldehyde resins, heat-reactive phenolic resins, phenol dialcohol resins, bisphenol resins, and heat-reactive bromomethylalkylated phenolic resins.

Examples of organic peroxides include alkyl peroxide, aryl peroxide, acyl peroxide, ketone peroxide, peroxy ketal, peroxycarbonate, peroxy ester, and hydroperoxide. As the organic peroxide, specifically, dicumyl peroxide can be suitably used.

Examples of triazine derivatives include 2,4,6-trimercapto-s-triazine, 2-methylamino-4,6-dimercapto-s-triazine, 2-(n-butylamino)-4,6-dimercapto-s-triazine, 2-octylamino-4,6-dimercapto-s-triazine, 2-propylamino-4,6-dimercapto-s-triazine, 2-diallylamino-4,6-dimercapto-s-triazine, 2-dimethylamino-4,6-dimercapto-s-triazine, 2-dibutylamino-4,6-dimercapto-s-triazine, 2-di(iso-butylamino)-4,6-dimercapto-s-triazine, 2-dipropylamino-4,6-dimercapto-s-triazine, 2-di(2-ethylhexyl)amino-4,6-dimercapto-s-triazine, 2-dioleylamino-4,6-dimercapto-s-triazine, 2-laurylamino-4,6-dimercapto-s-triazine, or 2-anilino-4,6-dimercapto-s-triazine, sodium salts thereof, and disodium salts thereof.

The amount of the crosslinking agent added may be appropriately adjusted, and is generally in a range of 0.01 parts by mass or more and 15 parts by mass or less, preferably in a range of 0.1 parts by mass or more and 10 parts by mass or less, and more preferably in a range of 0.1 parts by mass or more and 5 parts by mass or less with respect to 100 parts by mass of the rubber component.

The temperature during crosslinking may be appropriately adjusted, and may be generally in a range of 20° C. or higher and 200° C. or lower.

### [Additive for Rubber]

As described above, the rubber composition and rubber of the present invention can be obtained by blending the oxidized cellulose of the first aspect and/or the nanocellulose of the first aspect into a rubber component. In addition, the rubber composition and rubber of the present invention can be obtained by blending a composite nanocellulose grafted to a rubber component into a rubber component. That is, the oxidized cellulose of the first aspect, the nanocellulose of the first aspect, or the composite nanocellulose grafted to a rubber component of the present invention is an additive used in the rubber. The oxidized cellulose of the first aspect, the nanocellulose of the first aspect, or the composite nanocellulose grafted to a rubber component of the present invention is preferably added in order to strengthen the rubber, but the effect of addition is not limited to this.

One aspect of the present invention is an additive for rubber containing oxidized cellulose, wherein the oxidized cellulose contains an oxide of a cellulose raw material by a hypochlorous acid or a salt thereof and is substantially free of N-oxyl compounds. One aspect of the present invention is an additive for rubber containing nanocellulose, wherein the nanocellulose contains an oxide of a cellulose raw material by a hypochlorous acid or a salt thereof and is substantially free of N-oxyl compounds. One aspect of the present invention is an additive for rubber containing a composite nanocellulose grafted to a rubber component, wherein the nanocellulose is nanocellulose having an anion modification group.

The aspects of oxidized cellulose and nanocellulose used in the additive for rubber of the present invention are the same as the <Oxidized cellulose of first aspect> and <Nanocellulose of first aspect> described above. The aspect of the composite nanocellulose grafted to a rubber component is as described in the above [Rubber composition: second aspect].

The properties of the additive for rubber of the present invention are not particularly limited, and may be a liquid or a solid. The additive for rubber of the present invention may be in the form of a dried product of oxidized cellulose or (composite) nanocellulose or form of a dispersed liquid of oxidized cellulose or (composite) nanocellulose. When the additive for rubber is a dispersed liquid, it contains a dispersion medium in which oxidized cellulose or (composite) nanocellulose can be dispersed. The dispersion medium is not particularly limited, and can be appropriately selected depending on the purpose. Specific examples of dispersion media include water, alcohols, ethers, ketones, N,N-dimethylformamide, N, N-dimethylacetamide, and dimethyl sulfoxide. As the dispersion medium, one of these may be used alone or two or more thereof may be used in combination

Among the dispersion media, examples of alcohols include methanol, ethanol, isopropanol, isobutanol, sec-butyl alcohol, tert-butyl alcohol, methyl cellosolve, ethylene glycol and glycerin. Examples of ethers include ethylene glycol dimethyl ether, 1,4-dioxane and tetrahydrofuran. Examples of ketones include acetone and methyl ethyl ketone.

When the oxidized cellulose or (composite) nanocellulose is in the form of a dispersed liquid, the concentration of the oxidized cellulose or (composite) nanocellulose in the dispersing liquid may be generally in a range of 0.01 to 99 mass %. In consideration of availability and handling properties, the concentration is preferably in a range of 0.5 to 50 mass %, more preferably in a range of 1 to 30 mass %, and still more preferably in a range of 1 to 20 mass %.

### EXAMPLES

Hereinafter, the present invention will be described in detail with reference to examples. Here, the present invention is not limited to these examples. Here, in the following, “parts” and “%” indicate parts by mass and mass % unless otherwise specified.

Methods for measuring physical properties of nanocellulose and oxidized cellulose were as follows.

### <Method for Measuring Fiber Length and Fiber Width>

Pure water was added to an aqueous dispersion of fine cellulose fibers, and the concentration of fine cellulose fibers in the CNF aqueous dispersion was adjusted to 5 ppm. After the concentration was adjusted, the CNF aqueous dispersion was naturally dried on a mica substrate, and the shape of the fine cellulose fibers was observed using a scanning probe microscope “MFP-3D infinity” (commercially available from Oxford Asylum) in an AC mode.

For the average fiber length, the obtained image was binarized and analyzed using image processing software “Image J.” For 100 or more fibers, the number average fiber length was determined according to fiber length= “peripheral length”/2.

For the average fiber width, using software bundled in “MFP-3D infinity,” for 50 or more fibers, the number average fiber width [nm] was determined according to cross-sectional height of shape image=fiber width.

### <Measurement of Carboxy Group Content>

A 0.1 M hydrochloric acid aqueous solution was added to 60 ml of an oxidized cellulose aqueous dispersion in which the concentration of oxidized cellulose was adjusted to 0.5 mass %, the pH was adjusted to 2.5, a 0.05 N sodium hydroxide aqueous solution was then added dropwise, the electrical conductivity was measured until the pH reached 11.0, and the carboxy group content (mmol/g) was calculated from the amount of sodium hydroxide (a) consumed in the neutralization stage of a weak acid with a mild change in the electrical conductivity using the following formula.

Carboxy group content=a (ml)×0.05/mass (g) of oxidized cellulose fibers

### Production Example 1: Production of Oxidized Cellulose

Pulp (KC Flock W100GK, commercially available from Nippon Paper Industries Co., Ltd.) was used as a cellulose raw material.

350 g of sodium hypochlorite pentahydrate crystals having an available chlorine concentration of 42 mass % was put into a beaker, pure water was added, and the mixture was stirred to obtain a sodium hypochlorite aqueous solution having an available chlorine concentration of 21 mass %. 35 mass % hydrochloric acid was added thereto, the mixture was stirred and the pH was set to 11.0. This sodium hypochlorite aqueous solution was stirred at 200 rpm with a stirrer (three-one motor, BL600, commercially available from Shinto Scientific Co., Ltd.) having propeller type stirring blades, the temperature was set to 30° C. in a thermostatic water tank, and 50 g of the pulp was then added.

After the cellulose raw material was added, while maintaining the temperature in the same thermostatic water tank at 30° C., the pH during the reaction was maintained at 11.0 while adding a 48 mass % sodium hydroxide aqueous solution. Using the stirrer, stirring was performed at 60 rpm using three swept blades, and an oxidation reaction was performed for 4 hours (pH maintenance continued).

After the reaction was completed, the product was separated into a solid and a liquid by pressure filtration using filter cloth (KE022, an air-permeability of 0.3 cc/cm²/sec, commercially available from Nakao Filter Media Corporation), and the obtained oxidized cellulose solid was washed with pure water. The carboxy group content in the oxidized cellulose was 0.7 mmol/g.

Here, the available chlorine concentration in the sodium hypochlorite aqueous solution was measured by the following method.

### (Measurement of Available Chlorine Concentration in Sodium Hypochlorite Aqueous Solution)

0.582 g of an aqueous solution in which sodium hypochlorite pentahydrate crystals were added to pure water was accurately weighed, 50 mL of pure water was added, 2 g of potassium iodide and 10 mL of acetic acid were added, sealing was immediately performed, and the sample was left in a dark place for 15 minutes. After being left for 15 minutes, the released iodine was titrated with a 0.1 mol/L sodium thiosulfate solution (a solution factor of 1.000), and as a result (indicator starch test solution), the titration amount was 34.55 mL. A blank test was separately performed to perform correction, and since 1 mL of a 0.1 mol/L sodium thiosulfate solution corresponded to 3.545 mgCl, the available chlorine concentration in the sodium hypochlorite aqueous solution was 21 mass %.

### Example 1

The aqueous dispersion of oxidized cellulose (a solid content of 7.5%) obtained in Production Example 1 was treated with a homomixer (ROBOMIX, commercially available from Primix Corporation) at 10,000 rpm and a liquid volume of 300 mL for 46 minutes, and the oxidized cellulose was fibrillated into nanocellulose to obtain a nanocellulose aqueous disperssion liquid. The average fiber width was 3.7 nm, and the average fiber length was 150 nm.

20 parts by mass of the nanocellulose aqueous dispersion liquid was added to 100 parts by mass of the solid content of a polybutadiene latex (Nipol LX111A2, commercially available from Zeon Corporation; hereinafter referred to as “PB”), and the mixture was treated using a tabletop ultrasound system (MCS-6, commercially available from AS ONE) for 30 minutes and dispersed using an ultrasonic homogenizer (LUH150, commercially available from Yamato Scientific Co., Ltd.) for 30 seconds. PB was added thereto so that the nanocellulose concentration was adjusted to 5 parts by mass to obtain a rubber composition.

The rubber composition was cast onto a release paper film and dried at 50° C. for 3 days. The strength of the obtained rubber was tested according to <Strength evaluation> to be described below.

### Example 2

A nanocellulose aqueous dispersion liquid was obtained in the same manner as in Example 1.

20 parts by mass of the nanocellulose aqueous dispersion liquid was added to 100 parts by mass of the PB solid content, and the mixture was treated using a tabletop ultrasound system (MCS-6, commercially available from AS ONE) for 30 minutes and dispersed using an ultrasonic homogenizer (LUH150, commercially available from Yamato Scientific Co., Ltd.) for 30 seconds. After argon gas was bubbled at a flow rate of 100 mL/min for 30 minutes while stirring the dispersion liquid obtained by the dispersion treatment, UV irradiation (high pressure mercury lamp, Ushio SpotCure) was performed at 40° C. for 90 minutes. PB was added thereto so that the nanocellulose concentration was adjusted to 5 parts by mass to obtain a rubber composition.

The rubber composition was cast onto a release paper film and dried at 50° C. for 3 days. The strength of the obtained rubber was tested according to <Strength evaluation> to be described below.

### Comparative Example 1

PB was cast onto a release paper film and dried at 50° C. for 3 days. The strength of the obtained rubber was tested according to <Strength evaluation> to be described below.

### <Strength Evaluation>

Strength evaluation was performed according to the following tensile test.

Test pieces (thickness: 1.5 mm) obtained by punching out the rubbers obtained in Examples 1 and 2 and Comparative Example 1 into a length of 5 mm and a width 50 mm were subjected to the tensile test using a tensile testing machine (INSTRON 5566A, commercially available from INSTRON) at 23±2° C., a distance between marked lines of 10 mm, and a tensile speed of 100 mm/min based on JIS K6251.

According to the tensile test, the elastic modulus (Mpa), the tensile strength (TS (MPa)), the elongation at break (Eb (%)), the 50% modulus (σ50 (MPa)), the 300% modulus (o300 (MPa)), and the 800% modulus (0800 (MPa)) were measured.

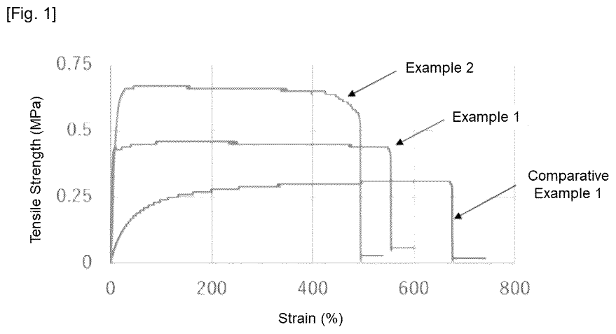

Table 1 shows the strength evaluation results of the rubbers obtained in Examples 1 and 2 and Comparative Example 1. In addition, FIG. 1 shows the tensile stress/strain measurement results of the rubbers obtained in Examples 1 and 2 and Comparative Example 1.

TABLE 1

| | | | | Comparative |
|---|---|---|---|---|
| | | Example | | Example |
| | | 1 | 2 | 1 |
| Rubber type | — | PB | PB | PB |
| Rubber content | Parts by | 100 | 100 | 100 |
| | mass | | | |
| Nanocellulose type | — | Hypochlo- | Hypochlo- | — |
| | | rous | rous | |
| | | acid | acid | |
| Nanocellulose | Parts by | 5 | 5 | 0 |
| content | mass | | | |
| DCP content | Parts by | 0 | 0 | 0 |
| | mass | | | |
| Crosslinked or not | — | Yes | Yes | Yes |
| UV irradiation or not | — | None | Yes | None |
| Rubber making | — | Cast | Cast | Cast |
| method | | | | |
| Broken or not | — | Broken | Broken | Broken |
| Elastic modulus | MPa | 10.45 | 16.19 | 0.95 |
| Tensile strength TS | MPa | 0.43 | 0.67 | 0.33 |
| Elongation at break | % | 534 | 490 | 605 |
| Eb | | | | |
| Modulus σ50 | MPa | 0.45 | 0.67 | 0.18 |
| Modulus σ300 | MPa | 0.45 | 0.66 | 0.29 |
| Modulus σ800 | MPa | — | — | — |

### Example 3

A nanocellulose aqueous dispersion liquid was obtained in the same manner as in Example 1.

5 parts by mass of a nanocellulose aqueous dispersion liquid solid content was added to 100 parts by mass of the solid content of a natural rubber latex (ULACOL, commercially available from Regitex Co., Ltd., solid content 61 wt %; hereinafter referred to as “NR”), the mixture was dispersed using a homomixer at 3,000 rpm for 1 minute, an additionally dispersed using a planetary stirrer (Thinky Mixer ARE310, commercially available from THINKY) Mix at 2,000 rpm for 1 minute and Defoam at 2,200 rpm for 1 minute to obtain a rubber composition.

This rubber composition was cast onto a plastic bat and dried with ventilation at 60° C. for 3 days to obtain a dried cast product.

This dried cast product was kneaded for 5 minutes using a batch type melt kneading machine (Labo Plastomill 10S100, mixer R60, Banbury type blade, commercially available from Toyo Seiki Co., Ltd.) under conditions of 70° C. and 60 rpm, 2 parts by mass of a crosslinking agent (Percumyl D (also referred to as DCP), commercially available from NOF Corporation) was added, the mixture was additionally kneaded for 10 minutes to obtain a kneaded product.

This kneaded product was put into a 1 mm thick mold, interposed between upper and lower SUS plates, and crosslinked and molded using a heat press machine at 165° C. and 20 MPa for 20 minutes to obtain a sheet-shaped rubber. The strength of the obtained sheet-shaped rubber was tested according to <Strength evaluation> to be described below.

### Example 4

A nanocellulose aqueous dispersion liquid was obtained in the same manner as in Example 1.

After mixing a rubber and nanocellulose in the same manner as in Example 2 except that the raw material was NR, the nanocellulose concentration was adjusted to 5 parts by mass to obtain a rubber composition.

This rubber composition was cast onto a plastic bat and dried with ventilation at 50° C. for 3 days to obtain a dried cast product.

This dried cast product was subjected to batch type melt kneading and then molding in the same manner as in Example 3, and the strength of the obtained sheet-shaped rubber was tested according to <Strength evaluation> to be described below.

### Example 5

A process of obtaining a rubber composition in the same manner as in Example 4 except that nanocellulose obtained by TEMPO oxidation was used as the nanocellulose aqueous dispersion liquid was attempted, but grafting did not proceed because the viscosity of the nanocellulose aqueous dispersion liquid was too high. Therefore, when nanocellulose obtained by TEMPO oxidation was used, a rubber composition was obtained in the same manner as in Example 4 although it was necessary to dilute the CNF concentration to 0.2%.

This rubber composition was cast onto a plastic bat and dried with ventilation at 50° C. for 3 days to obtain a dried cast product.

This dried cast product was subjected to batch type melt kneading and then molding in the same manner as in Example 3, and the strength of the obtained sheet-shaped rubber was tested according to <Strength evaluation> to be described below.

Here, the nanocellulose obtained by TEMPO oxidation was obtained by production according to Angew. Chem. Int. Ed. 2021, 60, 24630-24636.

### Comparative Example 2

NR was cast onto a plastic bat and dried at 50° C. for 3 days. This dried cast product was subjected to batch type melt kneading and heat pressing in the same manner as in Example 3 to obtain a sheet-shaped rubber. According to <Strength evaluation> to be described below, the strength of the obtained sheet-like rubber was tested.

### Comparative Example 3

A rubber composition was obtained in the same manner as in Example 3 except that nanocellulose obtained by TEMPO oxidation was used as the nanocellulose aqueous dispersion liquid.

This rubber composition was cast onto a plastic bat and dried with ventilation at 50° C. for 3 days to obtain a dried cast product.

This dried cast product was subjected to batch type melt kneading and then molding in the same manner as in Example 3, and the strength of the obtained sheet-shaped rubber was tested according to <Strength evaluation> to be described below.

### Comparative Example 4

A process of obtaining a rubber composition in the same manner as in Example 3 except that nanocellulose obtained by mechanical fibrillation was used as the nanocellulose aqueous dispersion liquid was attempted, but grafting did not proceed because the viscosity of the nanocellulose aqueous dispersion liquid was too high.

Here, the nanocellulose obtained by mechanical fibrillation was obtained by production according to “Raw Materials Evaluation Report for Promotion of the Use of CNF,” p. 40.

### <Strength Evaluation>

From the rubbers obtained in Examples 3 to 5 and Comparative Examples 2 and 3, dumbbell-shaped test pieces with a total length of 75 mm and a width between marked lines of 2 mm were prepared (thickness: 1.1 to 1.4 mm). A tensile test was performed on this sample using a tensile testing machine (INSTRON 5566A, commercially available from INSTRON) at 23±2° C., a distance between marked lines of 20 mm, and a tensile speed of 500 mm/min based on JIS K6251.

According to the tensile test, the elastic modulus (MPa), the tensile strength (TS (MPa)), the elongation at break (Eb (%)), the 50% modulus (o50 (MPa)), the 300% modulus (o300 (MPa)), and the 800% modulus (0800 (MPa)) were measured.

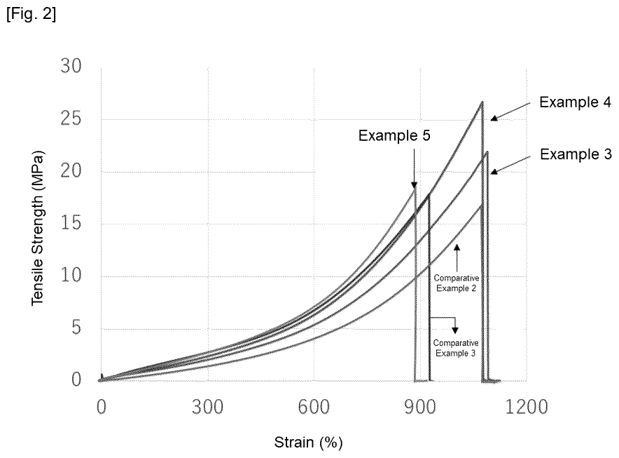

Table 2 shows the strength evaluation results of the rubbers obtained in Examples 3 to 5 and Comparative Examples 2 and 3. In addition, FIG. 2 shows the tensile stress/strain measurement results of the rubbers obtained in Examples 3 to 5 and Comparative Examples 2 and 3.

TABLE 2

| | | Example | | | Comparative Example | |
|---|---|---|---|---|---|---|
| | | 3 | 4 | 5 | 2 | 3 |
| Rubber type | — | NR | NR | NR | NR | NR |
| Rubber content | Parts by | 100 | 100 | 100 | 100 | 100 |
| | mass | | | | | |
| Nanocellulose type | — | Hypochlorous | Hypochlorous | TEMPO | — | TEMPO |
| | | acid | acid | | | |
| Nanocellulose | Parts by | 5 | 5 | 5 | 0 | 5 |
| content | mass | | | | | |
| DCP content | Parts by | 2 | 2 | 2 | 2 | 2 |
| | mass | | | | | |
| Crosslinked or not | — | Yes | Yes | Yes | Yes | Yes |
| UV irradiation or not | — | None | Yes | Yes | None | None |
| Rubber making | — | Kneading | Kneading | Kneading | Kneading | Kneading |
| method | | | | | | |
| Broken or not | — | Broken | Broken | Broken | Broken | Broken |
| Elastic modulus | MPa | 1.01 | 1.08 | 1.56 | 0.91 | 1.43 |
| Tensile strength TS | MPa | 22.3 | 25.0 | 18.8 | 16.9 | 17.5 |
| Elongation at break | % | 1105 | 1144 | 890 | 1122 | 906 |
| Eb | | | | | | |
| Modulus σ50 | MPa | 0.48 | 0.53 | 0.80 | 0.41 | 0.73 |
| Modulus σ300 | MPa | 2.06 | 2.32 | 3.30 | 1.62 | 2.87 |
| Modulus σ800 | MPa | 10.43 | 11.12 | 14.61 | 7.35 | 13.18 |

1. (canceled)

2. A rubber composition comprising a nanocellulose and a rubber component,
wherein the nanocellulose has an anion modification group, and
wherein the rubber component is grafted to the nanocellulose.

3. The rubber composition according to claim 2,
wherein the nanocellulose comprises an oxide of a cellulose raw material by a hypochlorous acid or a salt thereof and is substantially free of a N-oxyl compound.

4. A rubber obtained by crosslinking the rubber composition according to claim 2.

5-9. (canceled)

10. A composite nanocellulose comprising a rubber component and a nanocellulose,
wherein the nanocellulose has an anion modification group, and
wherein the rubber component and the nanocellulose are grafted.

11. The composite nanocellulose according to claim 10,
wherein the nanocellulose comprises an oxide of a cellulose raw material by a hypochlorous acid or a salt thereof and is substantially free of a N-oxyl compound.

12. An additive for a rubber, the additive comprising the composite nanocellulose according to claim 10.

13. The rubber composition according to claim 2,
wherein the nanocellulose has a structure in which hydroxyl groups at the 2nd position and the 3rd position of the glucopyranose ring are oxidized and dicarboxy groups are introduced.

14. The composite nanocellulose according to claim 10,
wherein the nanocellulose has a structure in which hydroxyl groups at the 2nd position and the 3rd position of the glucopyranose ring are oxidized and dicarboxy groups are introduced.
